(19) United States
(12) Patent Application Publication
(10) Pub. No.: US 2007/0074547 A1
(43) Pub. Date: Apr. 5, 2007

(54) LOCK STRUCTURE FOR COUPLING KENSINGTON LOCK

(75) Inventor: Chin-Yi Wu, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ACCTON TECHNOLOGY CORPORATION, Hsinchu (TW)

(21) Appl. No.: 11/535,989

(22) Filed: Sep. 28, 2006

(30) Foreign Application Priority Data
Sep. 30, 2005 (TW) 94134160

(51) Int. Cl. E05B 73/00

(52) U.S. Cl. 70/58

(57) ABSTRACT

A lock structure suited for locating on a casing is provided. The casing is coupled to a Kensington Lock through the lock structure. The lock structure includes a position limit portion and a protrusion portion. The position limit portion has a position limit hole. The protrusion portion is formed as a part of structure of the position limit portion and is located around the position limit hole. After coupling the Kensington Lock with the lock structure, the Kensington Lock is fixed to the casing through the lock structure.

### CROSS-REFERENCE TO RELATED APPLICATION

This application claims the priority benefit of Taiwan application serial no. 94134160, filed on Sep. 30, 2005. All disclosure of the Taiwan application is incorporated herein by reference.

### BACKGROUND OF THE INVENTION

1. Field of the Invention

The present invention relates to a lock structure, and more particularly, to a Kensington lock structure for coupling to a casing with the same lock structure.

2. Description of Related Art

In recent years, the widely developed world wide web has greatly increased network communication services so that data transmission between computers is no longer limited by distance and mankind's reliance on network equipment increases every single day. To prevent unsolicited shifting or stealing of the network equipment, most network equipment is provided with a Kensington lock. In general, the Kensington Lock is locked onto a lock structure on the casing of the network equipment so as to prevent unsolicited shifting or stealing of the network equipment.

FIG. 1 is a diagram showing a Kensington Lock locking a conventional lock structure. As shown in FIG. 1, the conventional lock structure 100 is located on a casing 102. The lock structure 100 includes a position limit portion 1 10 and an extension portion 120. The position limit portion 110 is one part of the casing 102. The position limit portion 110 has a position limit hole 112. The position limit hole 112 allows a latching portion 12 of the Kensington Lock 10 to pass through so that the latching portion 12 protrudes from the position limit portion 110. In addition, the extension portion 120 is a metal sheet with an opening 122, wherein the extension portion 120 is connected to the surface of the casing 102 through mechanical processing (for example, welding). Furthermore, the opening 122 in the extension portion 120 is linked to the position limit hole 112 of the position limit portion 110. With this arrangement, the total thickness after adding the thickness of the casing 102 and the extension portion 120 together render the lock structure 100 having a thickness that matches the preset locking thickness of the Kensington Lock 10.

In the conventional technique, an extra extension portion has to be added to the surface of the casing (as shown by the element label 120 in FIG. 1) to render the lock structure having a thickness that matches the present locking thickness of the Kensington Lock. Because the conventional lock structure has to be provided with an extra metal sheet with an opening to serve as the extension portion, and that metal sheet has to be welded to the casing after positioning, the production cost of the lock structure is increased.

### SUMMARY OF THE INVENTION

Accordingly, at least one objective of the present invention is to provide a lock structure located on a casing and suitable for coupling to a Kensington Lock such that the lock structure has a lower production cost.

The foregoing Kensington Lock has an operation portion. The operation portion has a first contact surface. The operation portion is hinged to a pivot and that side of the operation portion for hinging with the pivot is securely connected to a first latching portion. The first latching portion protrudes from the first contact surface and the pivot protrudes from the first contact surface and extends to connect with a second latching portion. Therefore, a rotation of the pivot through the operation portion will rotate the second latching portion along an axis of the pivot relative to the first latching portion.

To achieve these and other advantages and in accordance with the purpose of the invention, as embodied and broadly described herein, the invention provides a lock structure suitable for locating on a casing, and the casing is coupled to a Kensington Lock through the lock structure. The lock structure includes a position limit portion and a protrusion portion. The position limit portion has a position limit hole and the first latching portion and the second latching portion correspond to the position limit hole. The protrusion portion is formed as a part of structure of the position limit portion and is located around the position limit hole. When the casing is coupled to the Kensington Lock through the lock structure, the first latching portion accommodated inside the position limit hole limits the rotation of the operation portion relative to the position limit portion along the axis of the pivot, and the second latching portion that passes through the position limit hole and is rotated at a preset angle along the axis of the pivot limits the movement of the operation portion relative to the position limit portion along the axis of the pivot.

According to one embodiment of the present invention, the protrusion portion may be formed by mechanically processing or stamping a part of structure of the position limit portion.

According to one embodiment of the present invention, the protrusion portion may have a ring-shape or include a plurality of protruding spots.

According to one embodiment of the present invention, the second latching portion may include a second contact surface. When the casing is coupled to the Kensington Lock through the lock structure, there is a preset distance between the surface of the protruding portion used for contacting the first contact surface and the surface of the position limit portion used for contacting the second contact surface. This distance may be between 2.5 mm to 4 mm.

Accordingly, the lock structure in the present invention utilizes a part of structure of the position limit portion around the position limit hole to form a protrusion portion so that the lock structure is able to satisfy the preset locking thickness requirement of the Kensington Lock. Furthermore, mechanically processing (for example, stamping) a part of structure of the position limit portion to form the protrusion portion is able to reduce the cost of producing the lock structure.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing a Kensington Lock locking a conventional lock structure.

FIG. 2 is a perspective view showing a Kensington Lock and a lock structure located on a casing according to one preferred embodiment of the present invention.

FIG. 3 is a schematic cross-sectional view showing the Kensington Lock and the lock structure shown in FIG. 2.

FIG. 4 is a front view of the lock structure located on the casing shown in FIG. 2.

FIG. 5 is a perspective view from another angle showing the Kensington Lock shown in FIG. 2.

FIG. 6A is a diagram showing the structure after coupling the Kensington Lock to the lock structure in FIG. 2.

FIG. 6B is a diagram showing the Kensington Lock of FIG. 6A at the position limit hole.

FIG. 7A is a diagram showing the structure after locking the Kensington Lock to the lock structure in FIG. 6A.

FIG. 7B is a diagram showing the Kensington Lock of FIG. 7A at the position limit hole.

FIG. 8 is a front view of a lock structure located on a casing according to another preferred embodiment of the present invention.

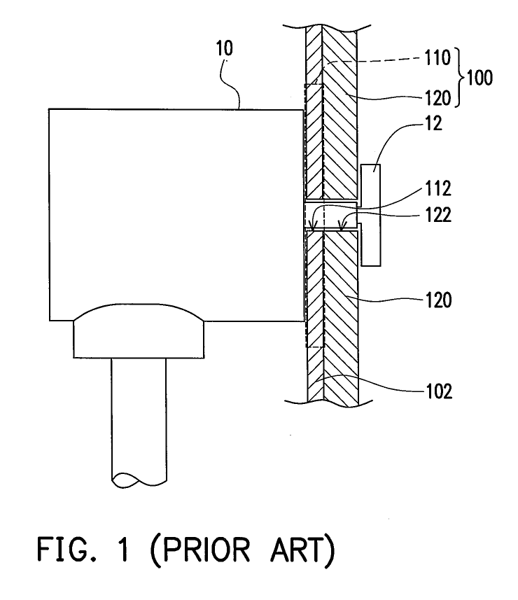

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

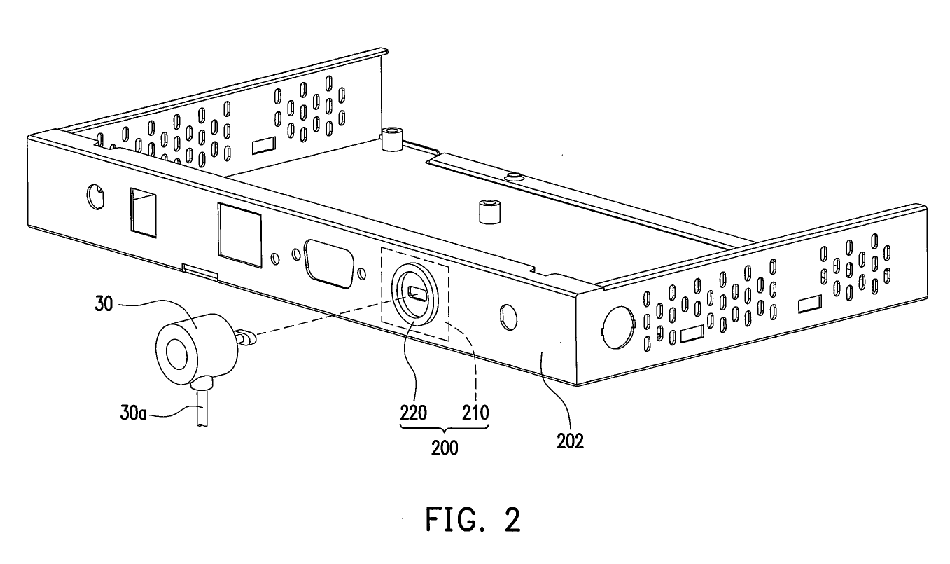

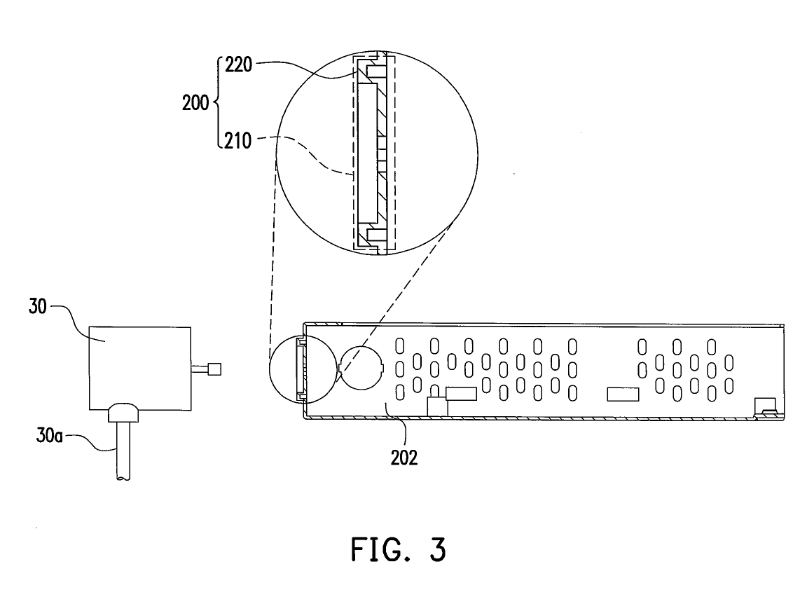

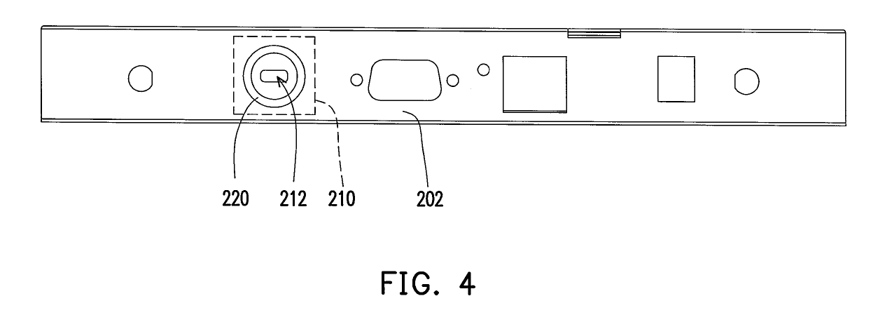

The lock structure according to the present invention is mainly located on the casing of an electronic apparatus (for example, network equipment) for locking with a Kensington Lock. FIG. 2 is a perspective view showing a Kensington Lock and a lock structure located on a casing according to one preferred embodiment of the present invention. FIG. 3 is a schematic cross-sectional view showing the Kensington Lock and the lock structure shown in FIG. 2. FIG. 4 is a front view of the lock structure located on the casing shown in FIG. 2. As shown in FIGS. 2, 3 and 4, the lock structure 200 in the present embodiment is suited for locating on a casing 202. The casing 202 is the casing of an electronic apparatus, for example. The casing 202 is coupled to a Kensington Lock 30 through the lock structure 200. By locking of the Kensington Lock 30 with the lock structure 200 located on the casing 202 and connecting a cable 30a set up on the Kensington Lock to a fixed end (not shown), the electronic apparatus is fixed inside a definite range relative to the fixed end. Obviously, the lock structure 200 can be also applied to the casing of other apparatus for locking with a Kensington Lock 30.

To understand how the Kensington Lock 30 is able to couple to the casing 202 through the lock structure 200, the following provides a detailed description of the coupling relationships between the Kensington Lock 30 and the lock structure 200.

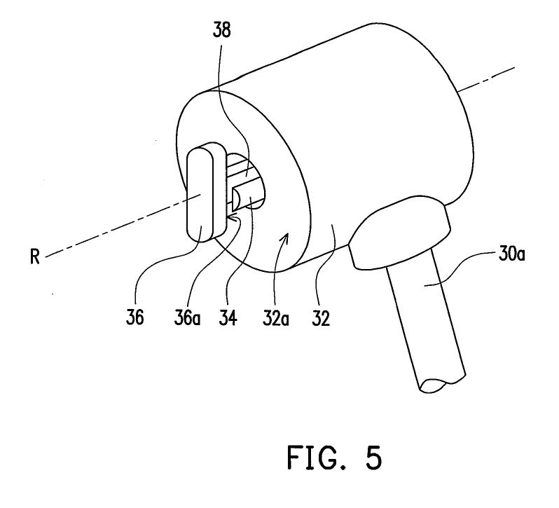

First, a detailed description of the Kensington Lock 30 is provided. FIG. 5 is a perspective view from another angle showing the Kensington Lock shown in FIG. 2. As shown in FIG. 5, the Kensington Lock 30 includes an operation portion 32. The operation portion 32 has a first contact surface 32a. The operation portion 32 is hinged to a pivot 38. A first latching portion 34 is fixed on one side of the pivot 38. The first latching portion 34 protrudes from the first contact surface 32a, and the pivot 38 protrudes from the first contact surface 32a and extends to connect with a second latching portion 36. Therefore, by rotating the pivot 38 through the operation portion 32, the second latching portion 36 is rotated relative to the first latching portion 34 along an axis R of the pivot 38. The second latching portion 36 has a second contact surface 36a.

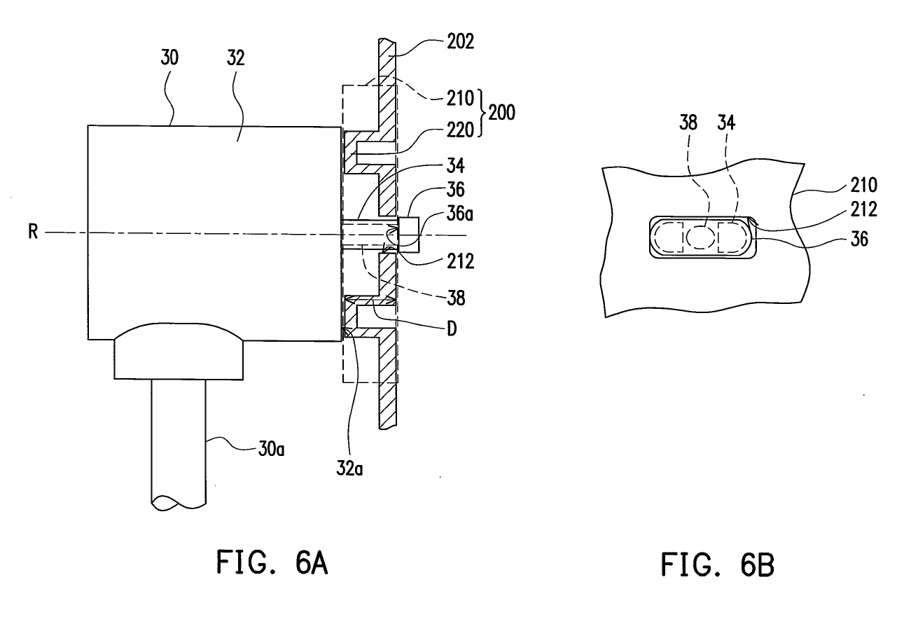

FIG. 6A is a diagram showing the structure after coupling the Kensington Lock to the lock structure in FIG. 2. FIG. 6B is a diagram showing the Kensington Lock of FIG. 6A at the position limit hole. As shown in FIGS. 6A and 6B, the lock structure 200 is suited for locating on the casing 202 and locking with the Kensington Lock 30. In the present embodiment, the lock structure 200 has a position limit portion 210 and a protrusion portion 220. The position limit portion 210 has a position limit hole 212. The first latching portion 34 and the second latching portion 36 of the Kensington Lock 30 correspond to the position limit hole 212. In other words, When the Kensington Lock 30 is coupled to the lock structure 200, the first latching portion 34 is accommodated inside the position limit hole 212 and the second latching portion 36 passes through the position limit hole 212 and latches with the position limit portion 210. It should be noted that the first latching portion 34 accommodated inside the position limit hole 212 limits the rotation of the operation portion 32 relative to the position limit portion 210 along the axis R of the pivot 38 when the casing 202 is coupled to the Kensington Lock 30 through the lock structure 200. Hence, the operation portion 32 is prevented from rotating relative to the position limit portion 210 along the axis R of the pivot 38.

The protrusion portion 220 is formed as one part of the position limit portion 210 and is located around the position limit hole 212. Furthermore, the protrusion portion 220 is formed by mechanically processing or stamping a part of structure of the position limit portion 210, for example. The protrusion portion 220 in the present embodiment has a ring-shaped structure (as shown in FIG. 4). On the other hand, when the Kensington Lock 30 is coupled to the casing 202 through the lock structure 200, there is a preset distance D between one surface of the protrusion portion 220 for contacting the first contact surface 32a and another surface of the position limit portion 210 for contacting the second contact surface 36a. This preset distance D is the lock thickness of the Kensington Lock and the lock thickness is, for example, between 2.5 mm to 4 mm.

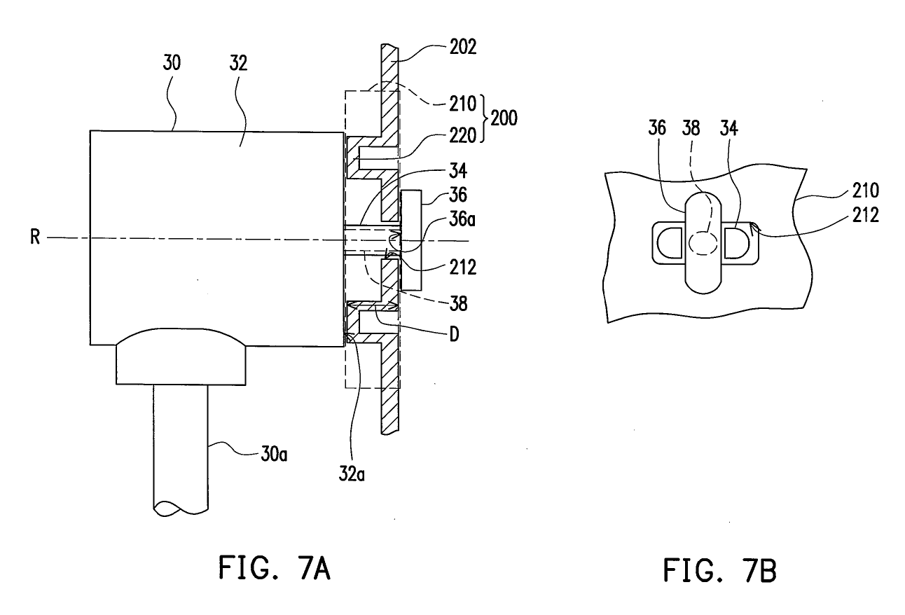

FIG. 7A is a diagram showing the structure after locking the Kensington Lock to the lock structure in FIG. 6A. FIG. 7B is a diagram showing the Kensington Lock of FIG. 7A at the position limit hole. As shown in FIGS. 7A and 7B, when the pivot 38 is rotated through the operation portion 38, the second latching portion 36 that passes through the position limit hole 212 is rotated by a preset angle, for example, a 90° angle, so that the second latching portion 36 and the position limit portion 210 are latched together. The second latching portion 36 rotates relative to the first latching portion 34 along an axis R of the pivot 3 8. The mutual latching between the second latching portion 36 and the position limit portion 210 is able to limit the movement of the operation portion 32 relative to the position limit portion 210 along the axis R of the pivot 38. In other words, the operation portion 32 cannot move relative to the position limit portion 210 along the axis R of the pivot 38.

Accordingly, after coupling the Kensington Lock 30 to the lock structure 200, rotating the pivot 38 through the operation portion 32 rotates the second latching portion 36 by a preset angle along the axis R of the pivot 38 and latches with the position limit portion 210 along the axis R. Therefore, the operation portion 32 cannot rotate relative to the position limit portion 210 along the axis R of the pivot 38 and the operation portion 32 cannot move relative to the position limit portion 210 along the axis R of the pivot 38. Eventually, the action of locking the Kensington Lock 30 with the lock structure 200 located on the casing 202 is complete.

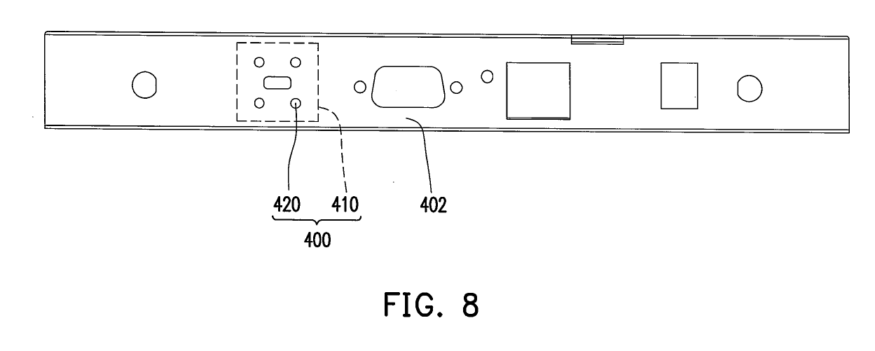

FIG. 8 is a front view of a lock structure located on a casing according to another preferred embodiment of the present invention. As shown in FIG. 8, the lock structure 400 in the present embodiment is similar to the lock structure 200 in the foregoing embodiment. The only difference is that the protrusion portion 420 in the lock structure 400 includes a plurality of protruding spots, wherein the protruding spots are also formed as a part of structure of the position limit portion 410. In addition, because the method of processing the protrusion portion 420 and the process of locking the Kensington Lock 30 with the lock structure 400 located on the casing 402 are identical to the previous embodiment, a detailed description is omitted.

In summary, the lock structure of the present invention utilizes a part of structure around the position limit hole of the position limit portion to form the protrusion structure so that the lock structure is able to satisfy the preset lock thickness requirement of the Kensington Lock. Thus, unlike the convention technique, there is no need to attach an extra metal sheet with a suitable thickness to the wall of the casing in order to satisfy the preset lock thickness requirement of the Kensington Lock as a result of the small thickness of the casing wall. Furthermore, a part of structure of the position limit portion may be mechanically processed (for example, stamping) to form the protrusion portion to reduce the cost of producing the lock structure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lock structure suitable for locating on a casing and coupling a Kensington Lock to the casing through the lock structure, wherein the Kensington Lock has an operation portion with a first contact surface, the operation portion is hinged to a pivot and a first latching portion is fixed on one side of the pivot, the first latching portion protrudes from the first contact surface, and the pivot protrudes from the first contact surface and extends to connect with a second latching portion such that rotating the pivot through the operation portion rotates the second latching portion relative to the first latching portion along an axis of the pivot, the lock structure comprising:
a position limit portion having a position limit hole, wherein the first latching portion and the second latching portion correspond to the position limit hole; and
a protrusion portion formed as a part of structure of the position limit portion and located around the position limit hole,
when the Kensington Lock is coupled to the casing through the lock structure, the first latching portion accommodated inside the position limit hole limits a rotation of the operation portion relative to the position limit portion along the axis of the pivot, and the second latching portion that passes through the position limit hole and is rotated at a preset angle along the axis of the pivot limits the movement of the operation portion relative to the position limit portion along the axis of the pivot.

2. The lock structure as claimed in claim 1, wherein the protrusion portion is formed by mechanically processing a part of structure of the position limit portion.

3. The lock structure as claimed in claim 2, wherein the protrusion portion is formed by stamping a part of structure of the position limit portion.

4. The lock structure as claimed in claim 1, wherein protrusion portion has a ring-shape.

5. The lock structure as claimed in claim 1, wherein the protrusion portion comprises a plurality of protruding spots.

6. The lock structure as claimed in claim 1, wherein the second latching portion comprises a second contact surface such that a preset distance between 2.5 mm to 4 mm exists between a surface of the protrusion portion for contacting with the first contact surface and a surface of the position limit portion for contacting with the second contact surface when the Kensington Lock is coupled to the casing through the lock structure.
